(19) United States
(12) Patent Application Publication
(10) Pub. No.: US 2026/0228358 A1
(43) Pub. Date: Aug. 6, 2026

(54) Excluding Sensitive Data from Enterprise AI Training and Generation Modules

(71) Applicant: DigiCert, Inc., Lehi, UT (US)

(72) Inventor: Samir Kumar Rakshit, Bengaluru (IN)

(73) Assignee: DigiCert, Inc., Lehi, UT (US)

(21) Appl. No.: 19/085,285

(22) Filed: Mar. 20, 2025

(30) Foreign Application Priority Data
Feb. 3, 2025 (IN) 202541008676

(51) Int. Cl. G06F 21/62

(52) U.S. Cl. CPC G06F 21/6245

(57) ABSTRACT

Systems and methods for providing training data from a digital trust management system are disclosed herein, including storing data associated with one or more operations within a secure repository of the digital trust management system, the data comprises a plurality of data elements, receiving, at the digital trust management system, a request to provide at least a portion of the stored data to an AI model for training, providing an interface configured to facilitate controlled access to the stored data by the AI model, prior to transmitting the requested data outside the digital trust management system, applying one or more filtering rules to the requested data based on sensitivity classifications of the data elements, and providing only non-sensitive data elements, as determined by the filtering, to the AI model for training, while excluding and retaining sensitive data elements within the confines of the digital trust management system.

### FIELD OF THE DISCLOSURE

The present disclosure generally relates to computer and networking systems and methods. More particularly, the present disclosure relates to systems and methods for securing training data provided to a LLM from a digital trust management system.

### BACKGROUND OF THE DISCLOSURE

As enterprises increasingly integrate artificial intelligence (AI) capabilities into their operations, they face significant challenges in managing and safeguarding data. AI technologies, including machine learning models for training and generative models for content creation, rely on vast amounts of input data to function effectively. However, this reliance introduces risks, as sensitive information may inadvertently enter AI workflows. Examples of such sensitive information include cryptographic secrets, personally identifiable information (PII), and proprietary intellectual property. The unintended exposure or misuse of this data can lead to severe consequences.

Compliance with regulatory frameworks such as the General Data Protection Regulation (GDPR), the Health Insurance Portability and Accountability Act (HIPAA), and other data protection mandates requires organizations to implement stringent measures to protect sensitive data. Additionally, internal governance policies often impose further obligations to ensure that sensitive content remains shielded from unauthorized access or use. The failure to meet these requirements can result in regulatory violations, reputational harm, and the potential disclosure of valuable proprietary assets to unauthorized parties or malicious actors.

Despite these risks, many organizations lack robust protocols to identify, categorize, and filter sensitive content before it is ingested into AI workflows. This gap exposes enterprises to compliance challenges, security vulnerabilities, and operational inefficiencies. As the adoption of AI technologies continues to expand across industries, addressing these challenges is critical to ensuring the responsible and secure use of AI systems.

### BRIEF SUMMARY OF THE DISCLOSURE

The present disclosure relates to systems and methods for excluding sensitive data, cryptographic secrets, personally identifiable information, and intellectual property from enterprise AI training and generation modules. In some aspects, the present disclosure includes utilizing a proxy in conjunction with an AI model configured to protect sensitive data, intellectual property, customer information, etc. from being exposed to AI models owned by outside entities or that are publicly available. The proxy can be configured to intercept flow data before the data reaches the AI model and can identify and optionally exclude sensitive data.

In one aspect, disclosed is a method for providing training data from a digital trust management system, the method including storing data associated with one or more operation within a secure repository of the digital trust management system, receiving, at the digital trust management system, a request to provide at least a portion of the stored data to an AI model for training, providing an interface configured to facilitate controlled access to the stored data by the AI model, prior to transmitting the requested data outside the digital trust management system, applying one or more filtering rules to the requested data based on sensitivity classifications of the data elements, and providing only non-sensitive data elements to the AI model for training while excluding and retaining sensitive data elements within the confines of the digital trust management system.

In another aspect, disclosed is a non-transitory computer-readable medium including instructions that, when executed, cause one or more processors to perform steps of store data associated with one or more operation within a secure repository of the digital trust management system, receive, at the digital trust management system, a request to provide at least a portion of the stored data to an AI model for training, provide an interface configured to facilitate controlled access to the stored data by the AI model, prior to transmitting the requested data outside the digital trust management system, apply one or more filtering rules to the requested data based on sensitivity classifications of the data elements, and provide only non-sensitive data elements to the AI model for training while excluding and retaining sensitive data elements within the confines of the digital trust management system.

### BRIEF DESCRIPTION OF THE DRAWINGS

The present disclosure is detailed through various drawings, where like components or steps are indicated by identical reference numbers for clarity and consistency.

FIG. 1 depicts a block diagram of a computing system in accordance with one aspect of the present disclosure.

FIG. 2 depicts a flow chart of a method for filtering sensitive data via a proxy in accordance with another aspect of the present disclosure.

FIG. 3 provides a flow chart of a method for excluding sensitive data from an AI model in accordance with yet another aspect of the present disclosure.

### DETAILED DESCRIPTION OF THE DISCLOSURE

Again, the present disclosure relates to excluding sensitive data, cryptographic secrets, personally identifiable information, and intellectual property from enterprise AI training and generation modules. In some aspects, the present disclosure includes providing a digital trust management system as an intermediary layer. Such a layer can be configured to be a governance layer and can be disposed between the enterprise data sources and the AI modules. The system can be configured to continuously or periodically analyze incoming data streams. For example, the system can identify cryptographic secrets, PII, intellectual property, and other sensitive data. The system can include a classifier to classify the information, such as a rule-based classifier. The system can use a machine learning model trained to detect contextual indicators of sensitive information. Once identified, the system can utilize the digital trust management system to tag each piece of data with a corresponding sensitivity category.

The system can enforce one or more policies based on the tag. For example, the policy can urge the system to exclude such sensitive data from being passed to AI learning and generation pipelines. As a result, the system can be configured to allow only non-sensitive information to be made available to AI modules. One advantage of the system of the present disclosure is that only non-sensitive information can be transmitted, which for example can ensure compliance with regulatory standard and can protect for example intellectual property and preserve the integrity and confidentiality of enterprise data. As such, the approaches provided in the instant application can reduce the risk of sensitive data exposure, can support scalability of AI initiatives, and increase overall data governance within an enterprise.

In some aspects, the present disclosure provides a method for providing training data to AI models from a digital trust management system while ensuring the exclusion of sensitive data. More specifically, disclosed is a method including storing operational data within a secure repository of the digital trust management system and facilitating controlled access through an interface. Before transmitting any requested data to an AI model for training, the system can apply filtering rule-based on sensitivity classifications. The filtering process ensures that only non-sensitive data elements are provided to the AI model, with sensitive data elements, such as cryptographic secrets, personally identifiable information (PII), and intellectual property, retained within the system's confines. The disclosed method can include mechanisms for analyzing data, utilizing machine learning models trained to detect sensitive content through contextual indicators, metadata, and predefined patterns. Sensitive data is tagged with corresponding sensitivity categories, stored as metadata, and excluded from external transmission. By ensuring that only non-sensitive data elements are shared, the method can support compliance with data protection regulations, mitigate the risk of sensitive data exposure, and enhances enterprise data governance. Furthermore, the system can accommodate both internal and third-party AI models, maintaining strict safeguards to prevent unauthorized disclosure of sensitive information while enabling scalable and compliant AI training initiatives.

### Example Computing System Architecture

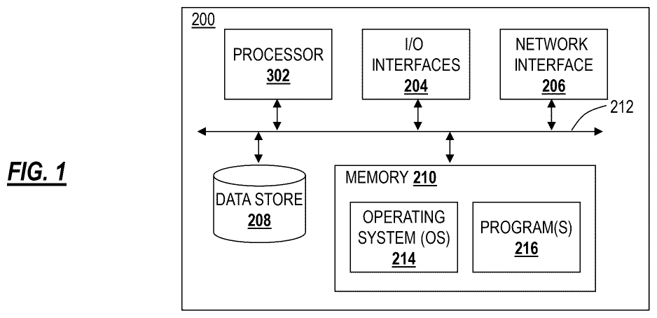

FIG. 1 illustrates a block diagram of a computing system 200 Conceptually, the computing system 200 can be implemented using various forms of underlying infrastructure, including physical servers, clusters of machines, virtual machines (VMs) running on hypervisors, or serverless computing frameworks. Regardless of its deployment model, the computing system 200 generally includes a processor 202, input/output (I/O) interfaces 204, a network interface 206, a data store 208, and memory 210.

It should be noted that FIG. 1 is a simplified representation of the computing system 200 and that practical implementations may employ additional hardware and software elements (e.g., accelerators, GPUs, FPGAs, dedicated cryptographic modules, caching layers, etc.) as well as more complex interconnect fabrics for high throughput and low latency. The illustrated components (202, 204, 206, 208, and 210) are coupled via a local interface 212, which may include one or more wired or wireless buses, high-speed interconnects, or sophisticated switching fabrics. In addition, the local interface 212 may incorporate a variety of controllers, buffers, caches, drivers, repeaters, and receivers, along with addressing and control lines, to facilitate efficient communication and resource sharing among components.

The processor 202 is a hardware device—such as a central processing unit (CPU), multicore processor, system-on-chip (SoC), or a processing element within a larger compute cluster—designed to execute software instructions. The processor 202 may be a general-purpose processor, a specialized processor, or a combination thereof, and it can be chosen based on performance, power efficiency, or workload requirements. When the computing system 200 operates, the processor 202 retrieves and executes instructions stored in the memory 210, orchestrating data exchanges with the data store 208 and managing the overall operations of the computing system 200. In larger deployments (e.g., the method 100), multiple processors 202 and parallel computing architectures may be employed to handle high traffic volumes and complex workloads efficiently.

The I/O interfaces 204 enable the computing system 200 to interact with external peripherals and devices, facilitating input from operators (e.g., through keyboards, touchscreens, or sensors) and output to displays, printers, or other systems. Depending on the application, the I/O interfaces 204 may also support specialized input devices for management, debugging, or maintenance of the system. The network interface 206 provides connectivity to external networks, such as the Internet 104, private corporate networks, or other cloud environments. This interface could be an Ethernet adapter, a Wireless LAN (WLAN) adapter, a 5G modem, or a virtual network interface in a cloud environment. It can support advanced network features like link aggregation, VLAN tagging, or software-defined networking (SDN) overlays. By leveraging secure transport protocols and encryption, the network interface 206 ensures that data exchanged over public or semi-public networks remains protected and that the computing system 200 can participate fully in distributed, cloud-based architectures.

The data store 208 represents storage resources where data can be held persistently or temporarily. Depending on the system requirements, the data store 208 may be implemented using volatile memory (e.g., RAM) for fast, transient storage or nonvolatile media (e.g., solid-state drives, hard disk drives, optical media) for durable, long-term data retention. In certain embodiments, the data store 208 can be integrated with external storage systems, network-attached storage (NAS), storage area networks (SAN), or cloud-based storage services. This flexibility allows the computing system 200 to accommodate various performance and capacity needs, scaling from small-footprint deployments to enterprise-grade installations. Data in the data store 208 may include operational logs, configuration files, policy data, program binaries, and cached results of computations. For example, in the context of the method 100, the data store 208 could store threat intelligence feeds, tenant policies, audit trails, analytics results, and more. External or distributed storage solutions can also be integrated, supporting global deduplication, compression, encryption at rest, and multi-site replication for resiliency and disaster recovery.

The memory 210 serves as the primary working memory for the processor 202. It can be composed of volatile memory elements like DRAM (including DDR, SDRAM) for rapid access, or it can include nonvolatile components, such as Flash memory or NVRAM, to provide a balance between speed and persistence. Memory 210 can also be distributed across multiple nodes or servers, enabling large in-memory data processing tasks commonly required by modern cloud applications. The memory 210 typically stores software, including the operating system (O/S) 214 and one or more programs 216. The O/S 214 manages fundamental system operations, such as process scheduling, memory allocation, file management, and network communication. Above the O/S layer, the programs 216 implement the specific logic and functionality described herein. They may include security modules, policy enforcement engines, threat detection algorithms, load balancing routines, or data analytics tools that enable the method 100 to function effectively.

In summary, the computing system 200 provides a foundational building block for implementing the present disclosure. Its modular, scalable hardware and software components empower the implementation of robust, flexible, and secure services, ensuring reliable operation and efficient execution of complex tasks in a wide range of computing scenarios.

### Processing Circuitry and Non-Transitory Computer-Readable Mediums

Those skilled in the art will recognize that the various embodiments may include processing circuitry of various types. The processing circuitry might include, but are not limited to, general-purpose microprocessors; central processing units (CPUs); digital signal processors (DSPs); specialized processors such as network processors (NPs) or network processing units (NPUs), graphical processing units (GPUs); field programmable gate arrays (FPGAs); programmable logic device (PLD), or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more application-specific integrated circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each equipped with processing circuitry. These instructions, when executed, enable the system to perform the functions as delineated and claimed in this document. Such non-transitory computer-readable storage mediums can include, but are not limited to, hard disks, optical storage devices, magnetic storage devices, read-only memory (ROM), programmable read-only memory (PROM), erasable programmable read-only memory (EPROM), electrically erasable programmable read-only memory (EEPROM), flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

### Data Governance Architecture

As enterprises increasingly incorporate advanced AI technologies—such as machine learning models for training and generative AI modules—into their operations, they encounter significant challenges in protecting sensitive information. This includes safeguarding cryptographic secrets, personally identifiable information (PII), and intellectual property (IP) to ensure compliance with data protection laws and to prevent misuse or unauthorized exposure of proprietary data. Directly ingesting vast quantities of raw internal data (e.g., images, text documents, numerical data, PDF files) into these AI systems, many of which may be provided or managed by external vendors, creates a substantial risk of non-compliance, reputational damage, and loss of competitive advantage. The present disclosure contemplates systems and methods for mitigating such risks.

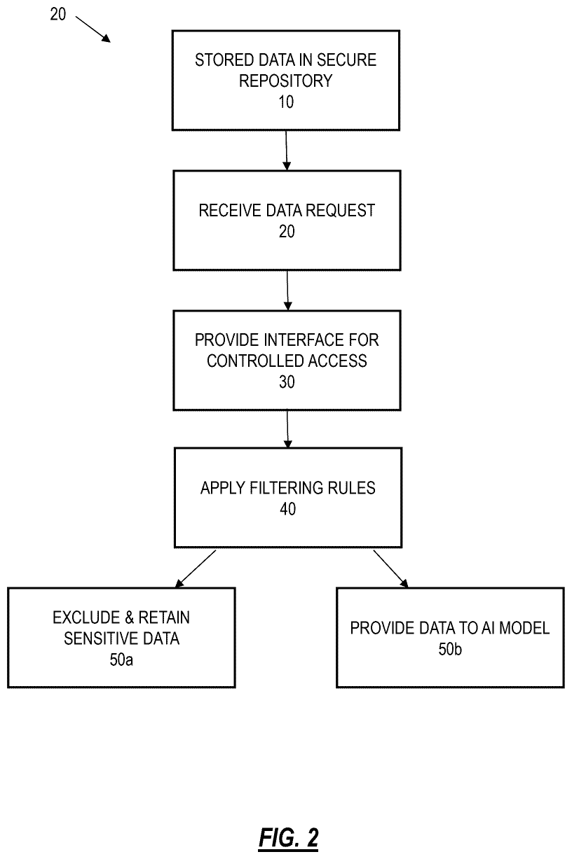

Turning now to FIG. 2, a flow chart 20 of a method for filtering sensitive data via a proxy is shown and described. The method can include integrating or deploying a digital trust management system (TLM engine) as a proxy. The TLM engine can be configured as an intermediary between a raw data source and an AI module. For example, the TLM engine can be an intermediary between stored data in a secure repository 10 and a training or generative AI component. The TLM engine can be configured to leverage advanced data governance policies, machine learning-based classifications, and rule based filters to inspect incoming data for sensitive content. The method can be deployed responsive to a receiving a data request 20. Once identified, the system can digitally tag such data as sensitive and can ensure that the data is either sanitized or excluded entirely. More generally the system can provide an interface for controlled access 30 and can apply filtering rules to the data 40. Based on the filtering rules, the system can either exclude & retain sensitive data 50a or provide the data to the AI model 50b.

The system can include the TLM engine. The TLM engine can define a proxy layer which can serve as an intermediary layer which can govern the flow of data between enterprise systems and AI models. As such, the TLM engine can ensure that sensitive data is appropriately managed and excluded from processing where its exposure could compromise security, privacy, or compliance standards. In some aspects, the TLM engine can be configured as a central point for enforcing data governance policies. The TLM engine can intercept data requests and responses and can provide real-time filtering, classification, and tagging of data based on, for example a predefined sensitivity categories. Such categories can include without limitation cryptographic secrets, personally identifiable information (PII), and intellectual property. The proxy layer provided via the TLM engine can include machine learning models, rule based classifiers, and contextual analysis to inspect data streams. Such mechanisms can identify patterns, key terms, or metadata indicative of sensitive content. From there, the TLM engine can categorize each data element according to a protection need.

Before transmitting data to the AI model, the TLM engine can apply one or more filtering rules. The filtering rules can be configured to identify rules to exclude sensitive elements. For example, sensitive data such as encryption keys, biometric information, or trade secrets can be retained within the system. The rules can ensure that only sanitized or non-sensitive data is made available for AI training. The TLM engine can be adapted as a mediator. More specifically, the TLM engine can ensure that data shared with AI system adheres to regulatory requirements (e.g., GDPR, HIPPA, etc.) and internal policies, thereby reducing the risk of inadvertent sensitive data exposure. Notably, the TLM engine and more generally the system of the present disclosure can be deployed against third-party AI providers.

The TLM engine, and more generally the system of the present disclosure can provide a secure interface for data access, which can allow fine-grained control over what information is accessible to internal or external Ai models. The interface can ensure transparency and traceability and can limit exposure to unauthorized access. In an exemplary aspect, each data element can be processed through the TLM engine and can be tagged with metadata reflecting its sensitivity category. This tagging can enable downstream systems and/or users are able to better handle data consistently with its classification, thereby preserving trust across operations. While acting as a proxy layer, the TLM engine can scale alongside enterprise systems and can adapt based on evolving data protection needs. The TLM engine can define a modular nature which can be adapted to facilitate integration with varying AI pipelines and enterprise data while maintaining effective trust management. More generally, the TLM engine can serve as an intermediary between raw data sources and the AI modules (including both training and generative AI components).

By using the TLM engine as a proxy layer, a reduced risk of sensitive data leakage can be achieved, which can ensure that sensitive information does not reach AI models, minimizing potential breaches or misuse. The TLM engine can also facilitate adherence to data protection laws and industry standards and can protect organizations from legal and financial repercussions. The TLM engine can centralize oversight of data flows and can provide consistent enforcement of trust policies. In some aspects, the TLM engine can provide secure sharing of non-sensitive data with third-party entities while simultaneously safeguarding sensitive assets. More generally, the TLM engine can be a proxy layer which can define secure policy-driven boundaries which allow a user or entity to leverage AI capabilities while maintaining control over sensitive data. For example only and without limitation, the TLM engine can be a trust lifecycle manager.

It is envisioned that the TLM engine acting as a proxy layer can be deployed in nearly limitless industries while ensuring sensitive data is protected. For example and without limitation, in healthcare, a TLM engine can filter out patient identifiers from electronic health records, providing only de-identified data to AI models for analysis, ensuring compliance with HIPAA. In finance, sensitive details like credit card numbers are excluded from fraud detection systems, aligning with PCI DSS standards. Tech companies can safeguard intellectual property by tagging and retaining trade secrets while sharing only non-sensitive product development data with AI models. E-commerce platforms can use the TLM engine to anonymize customer information while enabling AI-driven personalization. In government intelligence, classified information can be filtered out, allowing AI to analyze secure, non-sensitive data without compromising national security. Social media platforms can use the TLM engine to balance content moderation with user privacy by excluding private messages and personal identifiers from AI processing, adhering to GDPR.

Again, the TLM engine can operate as a core component of the system and can combine data governance policies, machine learning-based classification, and rule-based filtering to inspect incoming data for sensitive content. As such, the TLM engine acting as a proxy can ensure that data flows adhere to regulatory, privacy, and other operational requirements before being transmitted to AI systems for training or analysis. The TLM engine can implement a predefined governance policy to regulate data handling. Such policies can define sensitivity thresholds, categorization standards, and access controls to ensure compliance within a framework, such as GDPR, HIPPA, and PCI DSS. The TLM engine can use a trained machine learning model to analyze data context, metadata, and context for indicators of sensitivity. Such models can detect patterns, key terms, and data formats such as PIIs, cryptographic secrets, and intellectual property. The TLM engine can learn from past classifications and improve its accuracy in identifying such content.

The TLM engine can complement rule-based filter and can apply deterministic logic to inspect data for specific criteria, such as predefined keywords, patterns, or structures. For example, rules can identify a social security number by matching their format or detecting encrypting keys based on, for example length and usage patterns. The TLM engine can leverage contextual analysis to classify data elements. For example, the TLM engine can be structured to distinguish between a generic name in a public document and a personal identifier in a confidential record. Such contextual understanding can ensure that only truly sensitive data is flagged or excluded.

The TLM engine can perform real-time inspection and tagging as data streams through the system. For example, the TLM engine can label sensitive data elements with metadata indicating their classification, such as “PII” “intellectual property” or “cryptographic secret”. This tagging enables downstream systems to enforce handling requirements based on the tag. The TLM engine can ensure that sensitive data is excluded from datasets which are transmitted to AI models. The TLM engine can also retain sensitive data securely within the trust management system. Simultaneously, non-sensitive data can be filtered and approved for use, such as for supporting AI training and analysis without compromising confidentiality or compliance.

The use of such TLM engine as disclosed in the instant application can provide several benefits. For example, the TLM engine can prevent the exposure of sensitive information to unauthorized systems of third parties. The TLM engine can support adherence to legal and industrial standards by automating sensitive data detection and exclusion. The TLM engine can centralize policy enforcement and data flow oversight within the enterprise. Finally, the TLM engine can enable organizations to leverage AI capabilities securely by ensuring sensitive data is systematically managed and/or excluded. The TLM engine can integrate sophisticated governance policies, machine learning, and rule-based logic to inspect, classify, and control data in real-time. The TLM engine can be a gatekeeper between the enterprise and AI systems whereby the TLM engine only permits the AI to receive compliant, non-sensitive data and protecting sensitive data.

Once identified, the system can digitally tag such data as sensitive, ensuring that it is either sanitized or excluded entirely before the AI modules receive it. This tagging process can be based on comprehensive, customizable categories, including but not limited to: Sensitive Data: Keys, tokens, credentials, credit card details, and other elements that could enable unauthorized access if disclosed, Cryptographic Secrets: Private keys, API keys for cloud services, passwords, and passphrases that secure critical infrastructure, PII Information: Email addresses, Social Security Numbers (SSNs), home addresses, contact numbers, birthdates, biometric data, employment details, and medical or insurance records—any data that could identify a specific individual and Intellectual Property (IP): Inventions, patent filings, copyrighted works, trademarks, trade secrets, technical designs, and proprietary research.

By integrating the TLM engine into the enterprise's data pipeline, organizations can ensure that only non-sensitive, properly vetted information is passed on to AI systems. This approach aligns with global regulatory requirements (e.g., GDPR, HIPAA) and internal governance policies, significantly reducing the likelihood of accidental data leaks or malicious exploitation. In other words, by aligning with global privacy laws and industry standards, the TLM engine can provide that data sharing and processing activities adhere to strict legal requirements. For instance, under GDPR, organizations must protect personal data and prevent its misuse. The TLM engine identifies and excludes sensitive information like names, government IDs, or health records from AI datasets, reducing regulatory exposure.

Organizations often implement internal policies to safeguard proprietary information and maintain operational integrity. The TLM engine applies these governance policies, ensuring that intellectual property, trade secrets, and other critical business data remain confined to secure systems while non-sensitive data is processed by AI models. The TLM engine can continuously inspect incoming data streams for sensitivity, leveraging machine learning models to detect patterns and contextual indicators. Rule-based filters augment this by applying deterministic checks for formats like credit card numbers or encryption keys. By acting in real-time, the system prevents sensitive data from ever leaving the enterprise's controlled environment. Data breaches and leaks often occur when sensitive information is inadvertently shared with external systems or third parties. By integrating the TLM engine as a proxy, organizations ensure that sensitive data is flagged, retained, or securely deleted before reaching AI systems. This approach minimizes the risk of accidental exposure or malicious exploitation, such as cyberattacks targeting improperly secured data.

### TLM Engine as a Proxy

The present disclosure provides a method for providing training data from a DTMS (i.e., the TLM engine) to an AI model in a manner to ensure that sensitive information is excluded while allowing non-sensitive data to be utilized for AI training. More specifically, the approach of the instant application includes the TLM engine as the central mechanism for safeguarding data integrity and applying data governance.

One aspect includes storing or providing a storage of data, for example operational data. The data can include multiple data elements disposed within a secure repository managed by the DTMS (or TLM Engine). Such a repository can serve as the foundational layer and can be configured to retain or encapsulate all data in a controlled environment. The TLM engine can be configured to handle one or more requests for data intended for the AI model for training. For example, when a request is received, the system can evaluate the request and can initiate a process of preparing the appropriate subset of data. In some aspects, the system can provide an interface configured to control access to the stored data. Such an interface can be a gatekeeper configured to limit the requesting AI model to interactions only with the data under access controls, such as access controls structured with organizational governance policies and/or regulatory requirements. In some aspects, before transmitting the data to the AI model, the TLM engine can apply one or more filtering rules to the requested data. These rules can be based on a classification, such as a sensitivity classification, which can identify data elements as, for example, sensitive or non-sensitive. For example only sensitive elements like cryptographic secrets, PII, or intellectual property are flagged for exclusion. After filtering, only the non-sensitive data elements are transmitted to the AI model for training. Sensitive data elements are retained ensuring that they are not exposed to potential risks such as unauthorized access, data breaches, or misuse.

The system can organize the data into one or more distinct categories based on, for example, its nature and associated protection requirements. In some aspects, these categories can be defined in advance and can allow the system to enforce tailored rules for data handling. For example only, and without limitation, the categories can be Data flagged as highly sensitive (e.g., cryptographic secrets) may be entirely excluded from external sharing. Data with moderate sensitivity (e.g., personal identifiers) may require anonymization before use, and non-sensitive data may be shared without modification. As such, the structure allows the system to enforce policies across all data operations.

In some aspects, the system of the present disclosure can include sensitivity categories. The sensitivity categories can define the nature, type, properties, attributes, or any information relevant to the data. For example and without limitation, the system can include sensitivity categories including cryptographic secrets, which can include encryption keys, digital certificates, and secure tokens that are critical for maintaining secure communication and data integrity. Exposing such data could compromise system security or enable unauthorized access to protected resources. The system can include sensitivity categories including PII, including sensitive personal data, such as names, addresses, government-issued identifiers (e.g., Social Security numbers), or biometric data. PII is protected by laws like GDPR and HIPAA, requiring strict handling and anonymization to prevent misuse or breaches. In some aspects, the system can include sensitivity categories including IP or proprietary business information including trade secrets, confidential designs, and copyrighted materials essential to an organization's competitive advantage. Exposing such data could lead to loss of IP rights or financial harm. Again, the foreign is a non-exhaustive and non-limiting list intended as an illustrative example only.

In some aspects, the TLM engine can actively inspect data during operations to determine whether the individual data elements fall into the categories. The TLM engine can examine the actual content of the data, such as textual strings or numerical values to identify sensitive information (e.g., Social Security Numbers, encryption keys, etc.). The TLM engine can utilize metadata (e.g., file creation date, ownership details, access logs, etc.) to infer sensitivity. For example, the metadata can indicate if a document is confidential or contains proprietary information. The TLM engine can analyze the context in which the data is used or stored to determine sensitivity. For example, the data in a financial database can be inherently more sensitive than in a public repository. Once the analysis determines the sensitivity, the system can assign each element a sensitivity tag. The sensitivity tag can correspond to the element's classification. In example, these tags can be stored as metadata within the system, can serve as a mechanism for enforcing governance policies, such as filtering sensitive data prior to sharing, and can enable traceability and auditing by providing a transparent record of how and why each data element was classified.

The method of the present disclosure can include utilizing a machine learning (ML) model which can be configured or trained to automatically detect sensitive content by recognizing, for example, patterns (i.e., credit card numbers which typically follow specific numerical patters like 16 digits or starting with certain prefixes), key terms (i.e., Identifiers such as “confidential,” “proprietary,” or specific keywords like “encryption key” or “biometric.”), data formats (i.e., structured formats such as government IDs like Social Security numbers or file types often associated with intellectual property like CAD designs, source code), or contextual indicators (i.e., semantic analysis to infer sensitivity based on how data is described or where it is stored). This ML based approach can allow the TLM engine to analyze and classify vast amounts of data in real time which can reduce the requirement for manual oversight. As the system processes more data, the ML models can also improve through continuous learning, enhancing their accuracy over time. Once sensitive content is identified, the ML models integrate with the tagging mechanism to ensure that each data element is labeled with the appropriate sensitivity category. This integration supports consistent enforcement of data protection policies.

The TLM engine can enable the provider to utilize its proprietary information or services by securely utilizing only non-sensitive data. As such, an entity can improve its models without exposing sensitive information. Even when the data remains within the entity's ecosystem, the TLM engine can enforce compliance with regulations by filtering out sensitive elements before they are passed to the AI model. The provider can iterate and optimize internal system without fear of regulatory breaches.

In some aspects, the TLM engine can filter and transmit only non-sensitive data to a third party. Specifically, sensitive data elements are excluded during transmission between an entity and a third party to prevent unauthorized disclosure. This allows for protection of an entities data from exposure to external risks, whether accidental or malicious. The system maintains adherence to contractual obligations and regulatory standards by preventing data leaks to third parties.

The TLM engine can be configured to interact with AI training workflows through, for example, an application programming interface (API). The API can include authenticated access defining an authenticated access request for data which can ensure only authorized entities can access the system. The Api can automatically apply the TLM engine's filtering mechanism and can automatically return only non-sensitive data elements to the requestor. The API can enable easy connection with external AI training pipelines, making the TLM engine compatible with diverse systems and workflows. The API can support scalability and adaptability by allowing integration with modern could-based or on-premises AI platforms.

In typical aspects, the TLM engine is adapted as a proxy configured to protect data, IP, and cryptographic secrets during the adoption and use of AI models, such as those licensed or developed by large corporate entities. One function of the system of the present disclosure includes acting as an intermediary between an organization's data and the AI training model or generative processes. More generally, the TLM model or any component of the instant disclosure can be an intermediary disposed between an entity and an AI model and configured to secure the data therebetween.

Again, the TLM engine, the proxy mechanism, or any portion of system of the present disclosure can be disposed in a data flow path between an entity and an AI model. The system can include data pre-processing. Before the data is sent to the AI model, it can flow through the TLM engine. The TLM can analyze the data for sensitive elements (e.g., PII, proprietary content, cryptographic keys, etc.). Identified sensitive data can then be excluded or digitally tagged for exclusion. The TLM can operate as an intermediary system which can be integrated into the organization's data pipelines. As an intermediary, the TLM can ensure that only non-sensitive compliance-ready data is transmitted to the AI model. For example, the TLM can filter sensitive data and ensure compliance with legal and regulatory frameworks. The TLM can prevent inadvertent disclosure of sensitive information to third-party AI providers. The system can protect API documentation and sensitive operational data when exposed to AI models like ChatGPT.

In typical aspects, the TLM engine acts as a digital trust proxy positioned between the organization's data and the external AI model. The system can use advanced algorithms to detect sensitive data in various formats (e.g., text, images, PDFs, etc.). Sensitive data can be either excluded or flagged for exclusion before it is shared with the AI model. The TLM can be integrated with AI pipelines via an API, securing the TLM engine between the entity and the AI model.

### Exemplary System Architecture

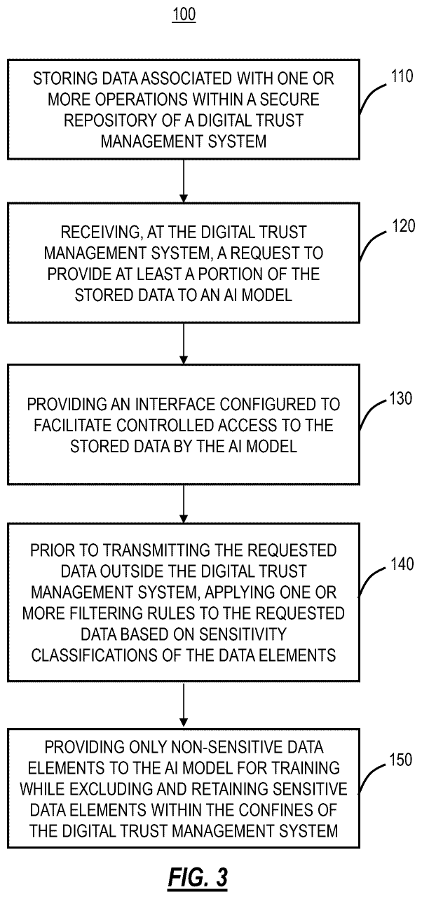

Turning now to FIG. 3, a flow chart of a method 100 for excluding sensitive data from an AI model is shown and described. The method 100 can include storing 110 data associated with one or more operations within a secure repository of a digital trust management system. The method 100 can include receiving 120 at the digital trust management system a request to provide at least a portion of the stored data to an AI model. The method 100 can include providing 130 an interface configured to facilitate controlled access to the stored data by the AI model. The method 100 can include prior to transmitting the requested data outside the digital trust management system, applying 140 one or more filtering rules to the requested data based on sensitivity classifications of the data elements. The method 100 can include providing only 150 non-sensitive data elements to the AI model for training while excluding and training sensitive data elements within the confines of the digital trust management system.

The method 100 can include wherein the data comprises a plurality of data elements. The method 100 can include wherein the non-sensitive data elements are determined by the filtering. The method 100 can include wherein sensitive data includes a data categorized into one or more predefined sensitivity categories, each category being associated with a defined level of data protection or handling requirement. The method 100 can include wherein the plurality of categories for sensitive data includes at least one of: (a) cryptographic secrets comprising encryption keys, digital certificates, or secure tokens, (b) personally identifiable information (PII), comprising names, addresses, government identifiers, or biometric data, and (c) intellectual property or proprietary business information, comprising trade secrets, confidential designs, or copyrighted materials.

The method 100 can further include analyzing the data during said operations to determine whether individual data elements belong to one of the plurality of categories by inspecting their content, metadata, and context, and tagging each associated data element with a corresponding sensitivity category based on the result of said analyzing, wherein the tagging is stored as metadata within the digital trust management system. The method 100 can include wherein the analyzing utilizes a trained machine learning model configured to automatically detect sensitive content by recognizing patterns, key terms, data formats, or contextual indicators that classify the associated data element into one or more of the plurality of categories.

The method 100 can include wherein the AI model is an internal model operated and maintained by a provider entity of the digital trust management system, enabling the provider entity to refine its own algorithms or services while ensuring compliance with data protection requirements. The method 100 can include wherein the AI model is controlled by a third-party entity separate from a provider of the digital trust management system, and wherein the filtering ensures that the third-party entity receives only non-sensitive training data, preventing unauthorized disclosure of protected information. The method 100 can include wherein the interface is an application programming interface (API) exposed by the digital trust management system, the API receiving authenticated requests for data and returning filtered, non-sensitive data elements, thereby enabling seamless integration with external AI training pipelines without compromising sensitive data.

### Conclusion

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown or described in the drawings, descriptions, and claims in a specific order, this does not imply they must be performed in that sequence unless explicitly stated. It also does not imply that all depicted operations are necessary to achieve desirable results. In the drawings, descriptions, and claims, extra steps can occur before, after, simultaneously with, or between any of the illustrated, described, or claimed steps. Multitasking, parallel processing, and other types of concurrent processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable order or manner—whether collectively, in subsets, or individually—thereby broadening the range of potential embodiments.

What is claimed is:

1. A method for providing training data from a digital trust management system, the method comprising:
storing data associated with one or more operations within a secure repository of the digital trust management system;
receiving, at the digital trust management system, a request to provide at least a portion of the stored data to an AI model for training;
providing an interface configured to facilitate controlled access to the stored data by the AI model;
prior to transmitting the requested data outside the digital trust management system, applying one or more filtering rules to the requested data based on sensitivity classifications of the data; and
providing only non-sensitive data to the AI model for training while excluding and retaining sensitive data within a confines of the digital trust management system.

2. The method of claim 1, wherein the data comprises a plurality of data elements.

3. The method of claim 1, wherein the non-sensitive data is determined by the filtering.

4. The method of claim 1, wherein the sensitive data includes data categorized into one or more predefined sensitivity categories, each category being associated with a defined level of data protection or handling requirement.

5. The method of claim 4, wherein the one or more predefined sensitivity categories for sensitive data includes at least one of:
(a) cryptographic secrets comprising encryption keys, digital certificates, or secure tokens;
(b) personally identifiable information (PII), comprising names, addresses, government identifiers, or biometric data; and
(c) intellectual property or proprietary business information, comprising trade secrets, confidential designs, or copyrighted materials.

6. The method of claim 1, further comprising:
analyzing the data during said operations to determine whether individual data elements belong one of a plurality of sensitive categories by inspecting their content, metadata, and context; and
tagging each associated data element with a corresponding sensitivity category based on a result of said analyzing, wherein the tagging is stored as metadata within the digital trust management system.

7. The method of claim 6, wherein the analyzing utilizes a trained machine learning model configured to automatically detect sensitive content by recognizing patterns, key terms, data formats, or contextual indicators that classify the associated data element into one or more of the plurality of sensitive categories.

8. The method of claim 1, wherein the AI model is an internal model operated and maintained by a provider entity of the digital trust management system, enabling the provider entity to refine its own algorithms or services while ensuring compliance with data protection requirements.

9. The method of claim 1, wherein the AI model is controlled by a third-party entity separate from a provider of the digital trust management system, and wherein the filtering ensures that the third-party entity receives only non-sensitive training data, preventing unauthorized disclosure of protected information.

10. The method of claim 1, wherein the interface is an application programming interface (API) exposed by the digital trust management system, the API receiving authenticated requests for data and returning filtered, non-sensitive data elements, thereby enabling seamless integration with external AI training pipelines without compromising sensitive data.

11. A non-transitory computer-readable medium comprising instructions that, when executed, cause one or more processors to perform steps of:
store data associated with one or more operation within a secure repository of a digital trust management system;
receive, at the digital trust management system, a request to provide at least a portion of the stored data to an AI model for training;
provide an interface configured to facilitate controlled access to the stored data by the AI model;
prior to transmitting the requested data outside the digital trust management system, apply one or more filtering rules to the requested data based on sensitivity classifications of the data; and
provide only non-sensitive data to the AI model for training while excluding and retaining sensitive data within a confines of the digital trust management system.

12. The non-transitory computer-readable medium of claim 11, wherein the data comprises a plurality of data elements.

13. The non-transitory computer-readable medium of claim 11, wherein the non-sensitive data is determined by the filtering.

14. The non-transitory computer-readable medium of claim 11, wherein the sensitive data includes data categorized into one or more predefined sensitivity categories, each category being associated with a defined level of data protection or handling requirement.

15. The non-transitory computer-readable medium of claim 14, wherein the one or more predefined sensitivity categories for sensitive data includes at least one of:
(a) cryptographic secrets comprising encryption keys, digital certificates, or secure tokens;
(b) personally identifiable information (PII), comprising names, addresses, government identifiers, or biometric data; and
(c) intellectual property or proprietary business information, comprising trade secrets, confidential designs, or copyrighted materials.

16. The non-transitory computer-readable medium of claim 11, further comprising:
analyzing the data during said operations to determine whether individual data elements belong to one of a plurality of predefined sensitivity categories by inspecting their content, metadata, and context; and
tagging each associated data element with a corresponding sensitivity category based on a result of said analyzing, wherein the tagging is stored as metadata within the digital trust management system.

17. The non-transitory computer-readable medium of claim 16, wherein the analyzing utilizes a trained machine learning model configured to automatically detect sensitive content by recognizing patterns, key terms, data formats, or contextual indicators that classify the associated data element into one or more of the plurality of sensitive categories.

18. The non-transitory computer-readable medium of claim 11, wherein the AI model is an internal model operated and maintained by a provider entity of the digital trust management system, enabling the provider entity to refine its own algorithms or services while ensuring compliance with data protection requirements.

19. The non-transitory computer-readable medium of claim 11, wherein the AI model is controlled by a third-party entity separate from a provider of the digital trust management system, and wherein the filtering ensures that the third-party entity receives only non-sensitive training data, preventing unauthorized disclosure of protected information.

20. The non-transitory computer-readable medium of claim 11, wherein the interface is an application programming interface (API) exposed by the digital trust management system, the API receiving authenticated requests for data and returning filtered, non-sensitive data elements, thereby enabling seamless integration with external AI training pipelines without compromising sensitive data.
